(19) United States
(12) Patent Application Publication
(10) Pub. No.: US 2005/0008997 A1
(43) Pub. Date: Jan. 13, 2005

(54) Portable endoscopic training and research device and methods of use

(75) Inventor: Lori J. Herman, Rochester, MN (US)

Correspondence Address: Hugh McTavish;McTavish Patent Firm, 429 Birchwood Courts, Birchwood, MN, 55110, US

(73) Assignee: Mayo Foundation for Medical Education and Research, Rochester, MN (US)

(21) Appl. No.: 10/887,151

(22) Filed: Jul. 8, 2004

Related U.S. Application Data
(60) Provisional application No. 60/485,625, filed on Jul. 8, 2003.

(51) Int. Cl. G09B 23/28

(52) U.S. Cl. 434/262; 434/267

(57) ABSTRACT

The invention provides portable devices for use in training in and developing endoscopic procedures. The invention also provides methods of using the devices to train in or develop endoscopic procedures.

This application claims the benefit of priority under 35 U.S.C. § 120 to U.S. provisional patent application Ser. No. 60/485,625, titled “Portable Endoscopic Training and Research Device and Methods of Use”, filed Jul. 8, 2003.

### FIELD OF THE INVENTION

The invention relates to endoscopic devices and methods, and more specifically to portable devices for training in or developing endoscopic procedures, and methods related thereto.

### BACKGROUND

In order to properly teach endoscopic procedures, it is desirable to use live animals. However, these animals must be sedated and are typically sacrificed after the procedures are completed. Opportunities to train and develop new procedures are thus limited due to the need to access and use live animals.

Some methods of training in endoscopic procedures use synthetic objects designed to simulate human organs, but these are typically less realistic than biological materials.

Some methods and apparatuses for training in endoscopy procedures use non-living biological materials (i.e., excised organs from slaughtered livestock). One drawback to the use of non-living biological materials is that the materials spoil rapidly.

Another drawback to the use of non-human animal organs, whether in the living animal or from slaughtered animals, in endoscopy training is that the anatomy of the animals differs from human anatomy.

New methods and devices for training in, or development of, endoscopy procedures are needed.

### SUMMARY

The present invention provides devices and methods for training in or developing gastrointestinal tract endoscopy procedures. The devices include gastrointestinal support tracts in a support surface to support excised organs from slaughtered animals. The support tracts are preferably designed to simulate human anatomy, thereby supporting the organs in the proper orientation for training medical students or physicians in the procedures. This permits persons to conduct endoscopy procedures on the organs without the need to use live animals.

In preferred embodiments, the devices are portable. The devices may also be insulated or cooled, allowing organs to be stored and transported within the devices. The portable devices may be used in areas and situations where the use of live animals would be inappropriate.

In preferred embodiments, the devices are small enough to fit in a typical refrigerator or freezer, allowing organs to be stored conveniently in a refrigerator or freezer to extend the time they can be used.

Accordingly, the invention provides a device for developing endoscopic procedures or training in endoscopic procedures, including: a support surface having a concave indentation in the form of a gastrointestinal tract section for mounting an excised mammalian gastrointestinal tract section in the indentation on the surface, the excised mammalian gastrointestinal tract section having an cephalad end and a caudad end; wherein the support surface (and preferably the device) has a length of less than about 29 inches and a width of less than about 20 inches. Preferably, the concave indentation in the form of a gastrointestinal tract section is in the form of a human gastrointestinal tract section.

The invention also provides a method of training in or developing an endoscopic procedure comprising: (1) mounting an excised mammalian gastrointestinal tract section on a concave indentation in the form of a gastrointestinal tract section on a support surface in a device, wherein the support surface has a length of less than about 29 inches and a width of less than about 20 inches; and (2) inserting an endoscopic device into the mounted mammalian gastrointestinal tract section to perform an endoscopic procedure.

### BRIEF DESCRIPTION OF THE DRAWINGS

FIG. 1 is a top angle view of an embodiment of an upper gastrointestinal tract support with biliary tree support of the present invention.

FIG. 2 is a top view of an embodiment of upper gastrointestinal tract support with a biliary tree support of the present invention.

FIG. 3 is a top angle view of an embodiment of a lower gastrointestinal tract support of the present invention.

FIG. 4 is a top view of another embodiment of an upper gastrointestinal tract support with a biliary tree support of the present invention.

FIG. 5 is a top view of another embodiment of a lower gastrointestinal tract support of the present invention.

FIG. 6 is a side view of an embodiment of a lower gastrointestinal tract colon adapter of the present invention.

FIG. 7 is a side view of an embodiment of an upper gastrointestinal tract esophagus adapter of the present invention.

FIG. 8 is an upper angle view of an embodiment of a device of the present invention.

FIG. 9 is a top view of an embodiment of the device holding a excised lower gastrointestinal tract section with a colon adapter.

FIG. 10 is a view of the interaction of the mesh and anchors that serve to hold the excised gastrointestinal tract section in place.

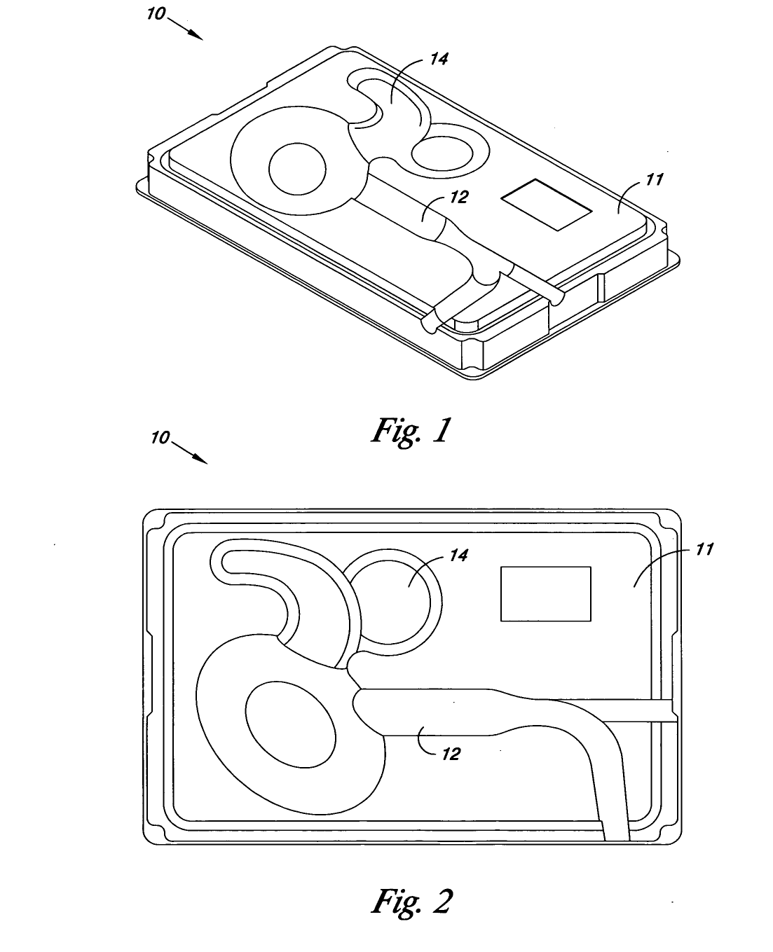

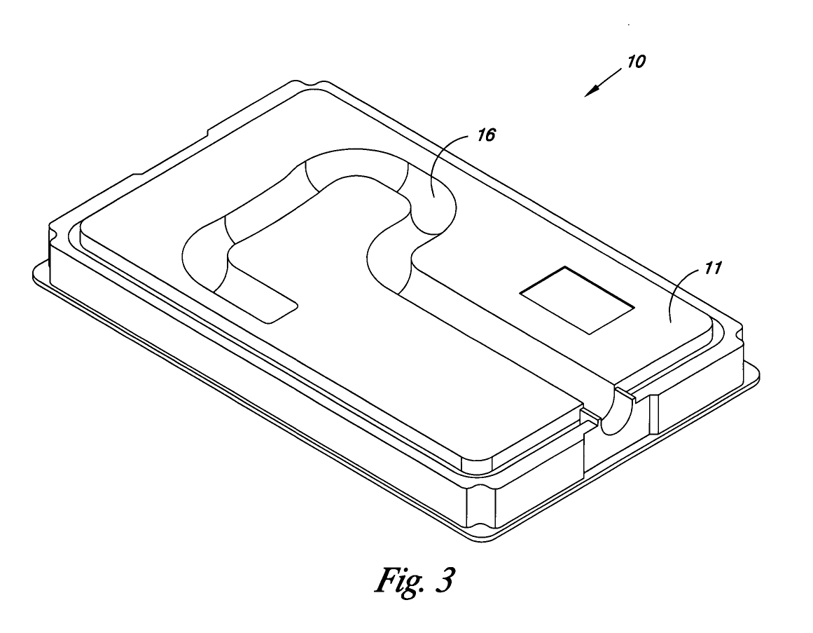

### DETAILED DESCRIPTION

Definitions:

“Length” of a support surface or a device refers to the longest linear dimension of the three primary axes of the support surface or device.

“Width” of a support surface or a device refers to the longer of the two linear dimensions along the axes perpendicular to the length axis.

The term “gastrointestinal tract” as used herein refers to the digestive tube running from the mouth to the anus, as well as the connected organs of the biliary tree.

The term “biliary tree” as used herein refers to the liver, gall bladder, optionally the pancreas, and bile ducts leading therefrom into the digestive tube.

“Cephalad” means toward the head and “caudad” means toward the tail in referring to the ends of the gastrointestinal tract sections.

Description:

The invention features devices and methods for training on endoscopic procedures or developing new endoscopic procedures. Endoscopic procedures are well known in the art and are described, for example, in Gastroenterologic Endoscopy, Sivak, Michael V., W. B. Saunders, 2000. Endoscopic procedures include hemostasis, mucosectomy, antireflux injection and plication, suturing, full thickness resection, endoscopic retrograde cholangiopancreatography (ERCP), gastrooscopy, colonoscopy, sigmoidoscopy, and polypectomy. Non-limiting examples of endoscopic procedures of the upper gastrointestinal tract include self-expanding metalic and non-metallic stent placement; band ligation; chromoscopy and magnification endoscopy; mucosal resection; foreign body retrieval; polypectomy; endoscopic retrograde cholangiopancreatography (ERCP), argon plasma coagulation; electrocoagulation; tattooing; anti-reflux therapy, including enteryx biopolymer injection, NDO full thickness plication, endocinch, ARD full thickness plication, and microsphere injection; tissue anchoring; overtube placement; widespread mucosectomy; submucosal fluid injection; tissue closure with clips for hemostasis and closure of perforation; and suturing. Endoscopic procedures of the lower gastrointestinal tract include self-expanding metal & non-metallic stent placement, polypectomy, mucosal resection, argon plasma coagulation, submucosal fluid injection, chromoscopy, tattooing, clip placement for hemostasis and closure of perforation, endoscopic retrograde cholangiography, sphincterotomy, stent placement, needle-knife sphincterotomy, balloon and basket extraction of common bile duct stones, biliary guidewire placement, brush cytology, forceps biopsy, and hydrostatic balloon dilatation.

With reference to the drawings, the device 10 includes a support surface 11 having a concave indentation 12 in the form of an upper gastrointestinal tract section for mounting an excised mammalian gastrointestinal tract section in the indentation 12 on the surface. Another embodiment of the device has a support surface 11 with a concave indentation 16 in the form of a lower gastrointestinal tract section for mounting an excised mammalian gastrointestinal tract section in the indentation 16 on the surface. The indentation is preferably shaped and dimensioned to simulate human anatomy and support excised non-human animal organs in the proper orientation to conduct endospcopic procedures. Dimensions in the drawings are shown in inches (millimeters in brackets). The support surface may be constructed of any suitable materials, including stainless steel, other lightweight metals, or lightweight polymers such as polyethylenes, polypropylene, polyester, polyimides, fluoropolymers, polycarbonates, polyurethanes, and polystyrenes. Preferably, the materials are lightweight, easy to form into shape in manufacture, and easy to clean after use. The tract supports may further be coated with biocompatible materials (e.g., DMSO compatible plastic).

The device may further include fasteners 18 mounted on the support surface for attaching the excised mammalian gastrointestinal tract section in the indentation on the surface. The fasteners can include screws, hooks, extensible webbing or any other suitable mechanism for holding the organs in place. The fasteners assist in maintaining correct positioning and support during an endoscopic procedure. The fasteners may include a combination of devices, such as screws with an attached webbing.

The device may include an outer case 20. The case may have two opposing sides 22 and 24. At least one side includes a gastrointestinal tract support surface. In a preferred embodiment, one side of the case includes a support surface with a concave indentation in the form of an upper gastrointestinal tract section, and the other opposing side has a support surface with a concave indentation in the form of a lower gastrointestinal tract section.

The case may include a handle 26 and latch mechanism 28. The case may include wheels and a telescoping handle for convenient transportation while traveling.

The opposing sides may be detachable from each other in order to simultaneously conduct procedures on both upper and lower gastrointestinal tract sections.

The case may be constructed of any suitable materials, including metals and plastics. Preferably, the materials are lightweight but provide strength to support and protect the support surfaces with the indentations for the gastrointestinal tract sections.

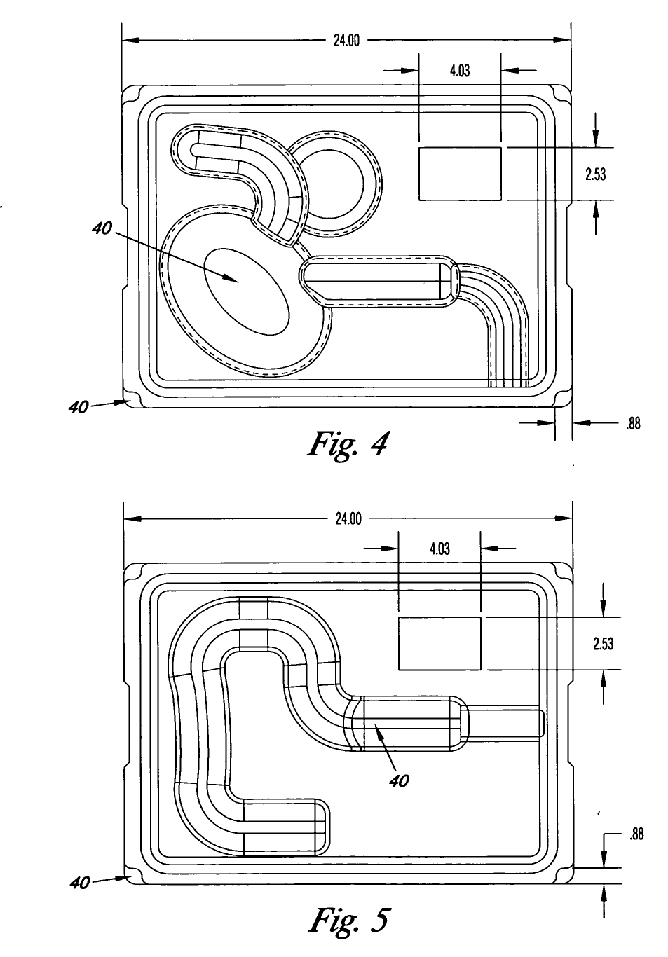

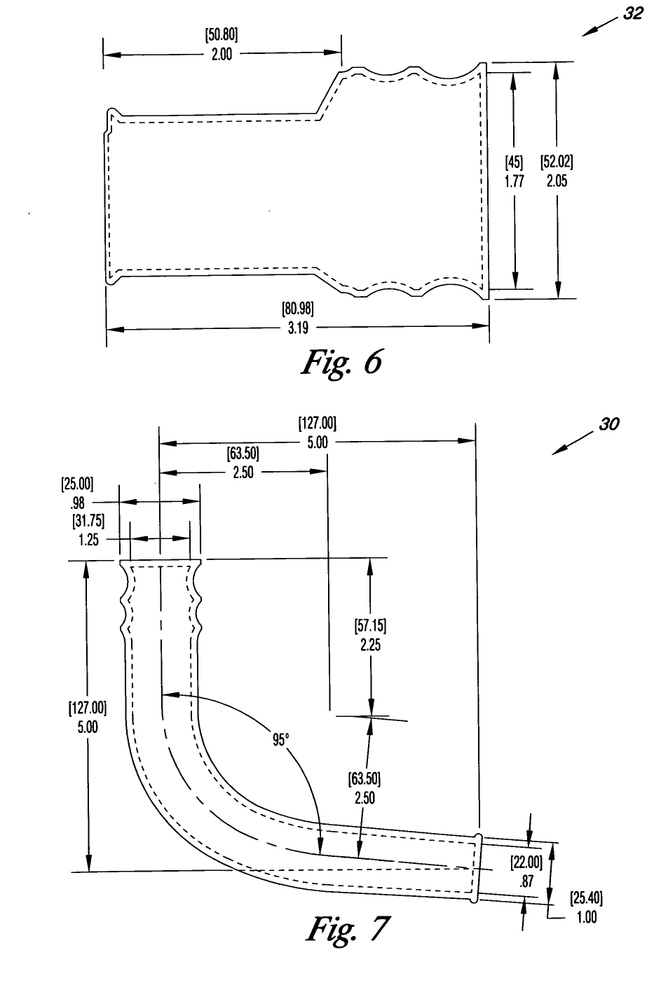

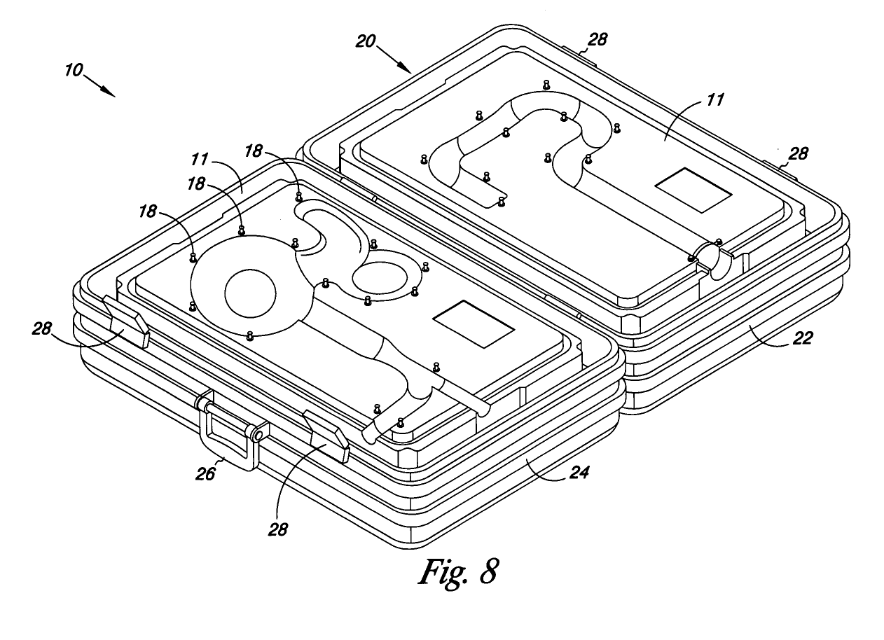

The rubber pads 40 referred to in FIGS. 4 and 5 are on the underside of the support surface or device, so the support surface or device can be placed on a table and resists sliding on the table during use.

The device may include insulating materials to preserve organs stored within the device or resting in use on the support surface. The insulating materials preferably are lightweight. Suitable insulating materials include foam, such as STYROFOAM™ insulating materials. The device may also include cooling elements to keep organs cool, either in storage or in use.

Optionally, an upper gastrointestinal tract esophagus adapter 30 may be included. The adapter may be designed to accommodate a range of endoscopic instruments that are placed through an endoscope internal instrument channel, alongside the endoscope and within an overtube which houses both the endoscope and endoscopic instrument. The adapter may be straight or angled and can be fashioned from glass or other durable materials. The angled adapter simulates the anatomy of the mouth and throat in order to duplicate the experience of passing an endoscope through this area in a human. The inner diameter of the adapter is sufficiently large to accommodate a range of instruments, overtubes, and endoscopes. Both ends of the adapter are typically modified. One end is modified to allow attachment of an animal esophagus. The cephalad opening of the esophagus typically fits over the end of the adapter. The other end may be modified to allow it to be fixed to the support surface.

The device may also include a lower gastrointestinal tract colon adapter 32. The colon adapter can be made from glass or other durable material, and should be of sufficient inner diameter to allow passage of common endoscopic devices. The colon adapter is open at both ends. One end is adapted to be attached to the caudad end of the excised lower gastrointestinal tract section. Typically, the end of the excised gastrointestinal tract section fits over the end of the colon adapter. The other end of the colon adapter is open and of sufficient diameter to allow entry of endoscopes, endoscopy instruments, and overtubes. That end may also be adapted to be fixed to the support surface.

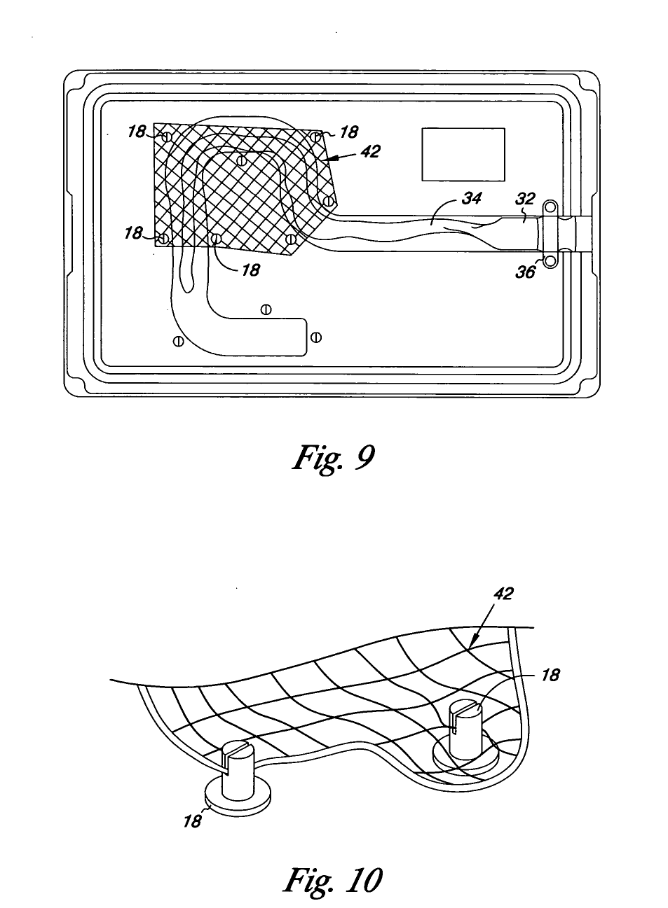

In use, the device has a gastrointestinal tract section held in the indentations on the support surface. The gastrointestinal tract section 34 in one embodiment, is held by an elastic mesh 42 that attaches to the anchors 18. A strap 36 may hold the colon adapter or esophagus adapter to the support surface, as shown in FIG. 9.

The elastic mesh 42 may attach to the anchors by placement in notches on the anchors 18 as shown in FIG. 10.

Prior to performing the endoscopy procedures, the excised gastrointestinal tract sections may be rinsed out inside and out. Making an incision at some point, such as in the stomach, may be useful in rinsing the contents from the gastrointestinal tract section. The open end (e.g. the duodenum of the upper gastrointestinal tract section or the cephalad end of the colon) as well as any incisions that were made should be closed off to prevent air flow through the openings. Closing the ends allows air pressure from the endoscope to expand the excised gastrointestinal section during the endoscopy procedure. The open ends and incisions can be closed by sutures or a stapler.

To use the device of the invention, excised gastrointestinal tract sections from a non-human animal are placed within the indentations in the support surface. The organs are secured to the support surface using fasteners. Optionally, an esophagus or colon adapter may be inserted in the appropriate end of the gastrointestinal tract section. Once the organs are secured, endoscopic procedures may be conducted.

Advantageously, organs from animals that have already been harvested may be used. This eliminates the need to destroy an animal after conducting a procedure and saves costs associated with the use of live animals. The device is easy to set up and use as compared to use of live animals. Use of the device permits easy visualization of the procedures, which is particularly useful in training.

One of the key advantages of the devices of the invention is they are smaller, lighter, and more portable than previous devices. In particular embodiments the devices weigh less than about 10 pounds. In particular embodiments, the devices, or at least the support surfaces within the devices, are smaller than about 29 inches in length and smaller than about 20 inches in width. Those dimensions allow the devices or support surfaces to fit in most standard refrigerators and freezers, allowing organs stored in the devices or on the support surfaces to be conveniently refrigerated. In other embodiments, the support surface and/or the device are smaller than about 26 inches in length and smaller than about 18 inches in width. The embodiments shown in FIGS. 4 and 5 are 24 in length.

In particular embodiments of the invention, the concave indentation in the support surface is in the form of a lower gastrointestinal tract section (e.g., a human lower gastrointestinal tract section).

In particular embodiments of the invention, the concave indentation in the support surface is in the form of an upper gastrointestinal tract section. Optionally, the concave indentation in the support surface in the form of an upper gastrointestinal tract section comprises a concave indentation in the form of a biliary tree or portion thereof for mounting an excised mammalian biliary tree or portion thereof attached to the gastrointestinal tract section in the biliary tree indentation. The biliary tree includes the liver, gall bladder, and extra-hepatic bile ducts. The pancreas with its main duct and intestinal attachment may also be included in the biliary tree.

Preferably, the lower and upper gastrointestinal tract indentations, including the biliary tree indentations, are dimensioned and shaped to correspond to the human anatomy. In other embodiments (e.g., to instruct veterinary students) they may be dimensioned and shaped to correspond to the anatomy of other species, such as dog, cat, cow, pig, or horse.

In some embodiments, the support surface includes indentations for both the lower gastrointestinal tract section and the upper gastrointestinal tract section, optionally with an indentation for the biliary tree or a portion thereof.

In some embodiments, the device includes a case in which the support surface is contained. Preferably the support surface is mounted in the case.

In some embodiments, the case contains (1) a first support surface that includes a concave indentation in the form of an upper gastrointestinal tract section for mounting an excised mammalian upper gastrointestinal tract section in the indentation on the surface; and (2) a second support surface that includes a concave indentation in the form of a lower gastrointestinal tract section for mounting an excised mammalian lower gastrointestinal tract section in the indentation on the surface.

In particular embodiments, the device includes a case having two opposing sides. In particular embodiments, the first opposing side has mounted therein a support surface that includes a concave indentation in the form of an upper gastrointestinal tract section for mounting an excised mammalian upper gastrointestinal tract section in the indentation on the surface; and the second opposing side has mounted therein a support surface that includes a concave indentation in the form of a lower gastrointestinal tract section for mounting an excised mammalian lower gastrointestinal tract section in the indentation on the surface.

In particular embodiments, the case with two opposing sides has a plurality of hinges linking the two opposing sides, and has a latch attached to one opposing side and arranged to latch the other opposing side. In some embodiments, the two opposing sides can be detached from each other to more conveniently perform endoscopic procedures on each opposing side.

In some embodiments, the devices that include a case have a handle mounted on the case. In some embodiments, the case has a plurality of wheels mounted on it to make transport easier. The case may also have an extendable handle.

In some embodiments, the device includes a plurality of fasteners mounted on the support surface for attaching the excised mammalian gastrointestinal tract section in the indentation on the surface.

In some embodiments, the fasteners are adapted for attachment thereto of a mesh adapted to hold the excised gastrointestinal tract section in the indentation on the support surface.

In some embodiments, the device includes an elastic fabric adapted to attach to the fasteners and to hold the excised gastrointestinal tract in the indentation on the surface.

In some embodiments, the device includes a mesh (i.e., an open weave fabric with spaces of at least about 2 mm between the fibers) adapted to attach to the fasteners and to hold the excised gastrointestinal tract in the indentation on the surface. Preferably, the mesh is elastic. An elastic butcher's mesh, used to wrap hams, has been found to be particularly suitable. It gives a resistance to movement of the organs in endoscopy that is similar to that provided by the surrounding tissue in the body when performing endoscopy on a living person.

In some embodiments, the device further includes an excised mammalian gastrointestinal tract section mounted in the indentation on the surface.

In particular embodiments, the excised mammalian gastrointestinal section is a pig gastrointestinal section. In some embodiments, the excised gastrointestinal section is a bovine gastrointestinal section, particularly a lower bovine gastrointestinal section.

In some embodiments, the device includes insulating material linked to the support surface for insulating the support surface. The insulating material linked to the support surface can be the material of the support surface itself or can be a separate material that insulates the support surface.

In some embodiments, the device includes cooling elements linked to the support surface for cooling the support surface.

In some embodiments, the device includes a colon adapter, the colon adapter being a section of tubing having two open ends, one end adapted to be attached to the caudad end of the excised mammalian lower gastrointestinal tract section.

In some embodiments, the device includes an esophagus adapter, the esophagus adapter being a section of tubing having two open ends, one end adapted to be attached to the cephalad end of the excised mammalian upper gastrointestinal tract section.

In some embodiments, the device includes an opaque material forming a blinding wall adapted to shield the support surface, or the organs mounted on the support surface, from the view of a user training on or performing an endoscopy procedure. The blinding wall could be a sheet of fabric hung in front of the device. It could be a rigid wall mounted on the support surface or the case. It could be a box that covers the support surface. The blinding wall of course must allow access to the organs with the endoscopy tools. This could be by holes or apertures in the blinding wall.

Foreign objects can be placed in the excised gastrointestinal tract sections to simulate certain abnormalities found and optionally corrected in endoscopy procedures. To simulate a bleeding artery, for instance, a 10 cm piece of silicone tubing can be used. An incision is made through, for instance, the stomach. A silicone tube is passed through the incision and seated so the end of the tube is level with the interior stomach wall. The tissue of the incision is glued to the tube with SUPERGLUE™ to seal the incision around the tube. A solution of artificial blood is pushed through the tube with a syringe or a pump to simulate a bleeding artery. Artificial blood can be created by a recipe of 5 tablespoons corn starch, ⅔ cup corn syrup, ⅓ cup water, 4 teaspoons red food coloring, and a couple of drops of green food coloring. An alternative recipe is 1 cup water, 3 teaspoons corn starch, 5 drops red food coloring, and 2 drops blue food coloring.

Bile stones can be simulated by placing beans or small stones in any of the biliary ducts.

Polyps can be simulated by making an incision through the exterior layer of colon tissue or the interior layer of the stomach, placing a bean or other object between two layers of tissue in the wall of the gastrointestinal tract, and suturing or gluing (e.g., with SUPERGLUE™) the incision closed.

To simulate a tumorous membrane in the colon, a solution of artificial blood is injected with a syringe into the mucosa layer of the colon tissue. This produces an identifiable discoloration.

Thus, one embodiment of the device is the device having an excised gastrointestinal tract section, further including tubing attached to the gastrointestinal tract section through a hole in the gastrointestinal tract section, the tubing composed of a synthetic material and adapted to carry a colored fluid to simulate a bleeding artery.

Another embodiment of the invention is the device having an excised gastrointestinal tract section, wherein the excised mammalian gastrointestinal tract section comprises at least two tissue layers, and a foreign object appropriately sized to simulate a polyp is placed between the two layers.

Another embodiment of a device of the invention is the device having an excised gastrointestinal tract section, wherein the gastrointestinal tract section is an upper gastrointestinal tract section including a biliary tree or portion thereof, wherein the biliary tree or portion thereof includes biliary ducts and the biliary ducts contain one or more foreign objects appropriately sized to simulate bile stones.

Another embodiment of a device of the invention is the device having an excised gastrointestinal tract section, wherein the gastrointestinal tract section is prepared by a process involving coloring the tissue of the excised gastrointestinal tract section (e.g., by injecting a solution of a colored liquid) at at least one point of the gastrointestinal tract section to generate discolored tissue simulating a tumor in the gastrointestinal tract section.

In certain embodiments of the methods of the invention, the endoscopic procedure the user is performing is self-expanding metalic and non-metallic stent placement, band ligation, chromoscopy, magnification endoscopy, mucosal resection, foreign body retrieval, polypectomy, endoscopic retrograde cholangiopancreatography (ERCP), argon plasma coagulation, electrocoagulation, anti-reflux therapy, including enteryx biopolymer injection, NDO full thickness plication, endocinch, ARD full thickness plication, microsphere injection, tissue anchoring, overtube placement, widespread mucosectomy, submucosal fluid injection, tissue closure with clips for hemostasis and closure of perforation, suturing, tattooing, endoscopic retrograde cholangiography, sphincterotomy, stent placement, needle-knife sphincterotomy, balloon and basket extraction of common bile duct stones, biliary guidewire placement, brush cytology, forceps biopsy, or hydrostatic balloon dilatation.

In certain embodiments, the methods involve inserting tubing through the wall of the gastrointestinal tract section, wherein the tubing is composed of a synthetic material and adapted to carry a colored fluid to simulate a bleeding artery.

In certain embodiments, the gastrointestinal tract section has at least two layers of tissue and the method involves incising the wall of the gastrointestinal tract section and placing a foreign object appropriately sized to simulate a polyp between the two layers of tissue.

In certain embodiments, the gastrointestinal tract section is an upper gastrointestinal tract section comprising a biliary tree or portion thereof, wherein the biliary tree or portion thereof include biliary ducts, and the method involves placing one or more foreign objects appropriately sized to simulate bile stones in at least one of the biliary ducts.

In certain embodiments, the methods involve injecting a colored liquid into tissue of the gastrointestinal tract section at at least one point of the gastrointestinal tract section to generate a discolored area in the wall of the gastrointestinal tract section that simulates a tumor.

It is to be understood that while the invention has been described in certain embodiments, the foregoing description is intended to illustrate and not limit the scope of the invention.

All cited patents, patent documents, and references cited herein are incorporated by reference.

1. A device for developing endoscopic procedures or training in endoscopic procedures, comprising:
a support surface comprising a concave indentation in the form of a gastrointestinal tract section for mounting an excised mammalian gastrointestinal tract section in the indentation on the surface, the excised mammalian gastrointestinal tract section having an cephalad end and a caudad end;
wherein the support surface has a length of less than about 29 inches and a width of less than about 20 inches.

2. The device of claim 1 wherein the concave indentation in the support surface is in the form of a lower gastrointestinal tract section.

3. The device of claim 2 wherein the concave indentation in the support surface is dimensioned and shaped to correspond to a human lower gastrointestinal tract section.

4. The device of claim 1 wherein the concave indentation in the support surface is in the form of an upper gastrointestinal tract section.

5. The device of claim 4 wherein the concave indentation in the support surface in the form of an upper gastrointestinal tract section comprises:
a concave indentation in the form of a biliary tree or portion thereof for mounting an excised mammalian biliary tree or portion thereof in the indentation on the surface.

6. The device of claim 4 wherein the concave indentation in the support surface is dimensioned and shaped to correspond to a human upper gastrointestinal tract section.

7. The device of claim 1 further comprising a case in which the support surface is contained.

8. The device of claim 7 wherein the support surface is mounted in the case.

9. The device of claim 7 wherein the case contains:
a first support surface comprising a concave indentation in the form of an upper gastrointestinal tract section for mounting an excised mammalian upper gastrointestinal tract section in the indentation on the surface, the excised mammalian upper gastrointestinal tract section having an cephalad end and a caudad end; and
a second support surface comprising a concave indentation in the form of a lower gastrointestinal tract section for mounting an excised mammalian lower gastrointestinal tract section in the indentation on the surface, the excised mammalian lower gastrointestinal tract section having an cephalad end and a caudad end.

10. The device of claim 7 wherein the case comprises:
two opposing sides;
the first opposing side having mounted therein a support surface comprising a concave indentation in the form of an upper gastrointestinal tract section for mounting an excised mammalian upper gastrointestinal tract section in the indentation on the surface, the excised mammalian upper gastrointestinal tract section having an cephalad end and a caudad end; and
the second opposing side having mounted therein a support surface comprising a concave indentation in the form of a lower gastrointestinal tract section for mounting an excised mammalian lower gastrointestinal tract section in the indentation on the surface, the excised mammalian lower gastrointestinal tract section having an cephalad end and a caudad end.

11. The device of claim 10 further comprising:
a plurality of hinges linking the two opposing sides; and
a latch attached to one opposing side and arranged to latch the other opposing side.

12. The device of claim 11 further comprising:
a plurality of wheels mounted on the case.

13. The device of claim 1 further comprising a plurality of fasteners mounted on the support surface for attaching the excised mammalian gastrointestinal tract section in the indentation on the surface.

14. The device of claim 13 wherein the fasteners are adapted for attachment thereto of a mesh adapted to hold the excised gastrointestinal tract section in the indentation on the surface.

15. The device of claim 13 further comprising an elastic fabric adapted to attach to the fasteners and to hold the excised gastrointestinal tract in the indentation on the surface.

16. The device of claim 14 further comprising a mesh adapted to attach to the fasteners and to hold the excised gastrointestinal tract in the indentation on the surface.

17. The device of claim 1 further comprising an excised mammalian gastrointestinal tract section mounted in the indentation on the surface, the excised mammalian gastrointestinal tract section having an cephalad end and caudad end.

18. The device of claim 17 wherein the excised mammalian gastrointestinal tract section is a pig gastrointestinal tract section.

19. The device of claim 17 wherein the excised mammalian gastrointestinal tract section is a bovine lower gastrointestinal tract section.

20. The device of claim 17 further comprising:
tubing attached to the gastrointestinal tract section through a hole in the gastrointestinal tract section, the tubing composed of a synthetic material and adapted to carry a colored fluid to simulate a bleeding artery.

21. The device of claim 17 wherein the excised mammalian gastrointestinal tract section comprises at least two tissue layers, wherein a foreign object appropriately sized to simulate a polyp is placed between the two layers.

22. The device of claim 17 wherein the gastrointestinal tract section is an upper gastrointestinal tract section comprising a biliary tree or portion thereof, wherein the biliary tree or portion thereof comprises biliary ducts and the biliary ducts comprise one or more foreign objects appropriately sized to simulate bile stones.

23. The device of claim 17 wherein the gastrointestinal tract section is prepared by a process comprising coloring the tissue of the gastrointestinal tract section at at least one point of the gastrointestinal tract section to generate discolored tissue simulating a tumor in the gastrointestinal tract section.

24. The device of claim 1 further comprising insulating material linked to the support surface for insulating the support surface.

25. The device of claim 1 further comprising cooling elements linked to the support surface for cooling the support surface.

26. The device of claim 2 further comprising a colon adapter, the colon adapter being a section of tubing having two open ends, one end adapted to be attached to the caudad end of the excised mammalian lower gastrointestinal tract section.

27. The device of claim 4 further comprising an esophagus adapter, the esophagus adapter being a section of tubing having two open ends, one end adapted to be attached to the cephalad end of the excised mammalian upper gastrointestinal tract section.

28. The device of claim 1 further comprising an opaque material forming a blinding wall adapted to shield the support surface from view by a user of the device.

29. A method of training in or developing an endoscopic procedure comprising:
mounting an excised mammalian gastrointestinal tract section in the indentation of the support surface of the device of claim 1; and
inserting an endoscopic device into the mounted mammalian gastrointestinal tract section to perform an endoscopic procedure.

30. The method of claim 29 wherein the endoscopic procedure is self-expanding metalic and non-metallic stent placement, band ligation, chromoscopy, magnification endoscopy, mucosal resection, foreign body retrieval, polypectomy, endoscopic retrograde cholangiopancreatography (ERCP), argon plasma coagulation, electrocoagulation, anti-reflux therapy, including enteryx biopolymer injection, NDO full thickness plication, endocinch, ARD full thickness plication, microsphere injection, tissue anchoring, overtube placement, widespread mucosectomy, submucosal fluid injection, tissue closure with clips for hemostasis and closure of perforation, suturing, tattooing, endoscopic retrograde cholangiography, sphincterotomy, stent placement, needle-knife sphincterotomy, balloon and basket extraction of common bile duct stones, biliary guidewire placement, brush cytology, forceps biopsy, or hydrostatic balloon dilatation.

31. The method of claim 29 further comprising:
inserting tubing through the wall of the gastrointestinal tract section, wherein the tubing is composed of a synthetic material and adapted to carry a colored fluid to simulate a bleeding artery.

32. The method of claim 29, wherein the gastrointestinal tract section has at least two layers of tissue, the method further comprising:
incising the wall of the gastrointestinal tract section, and placing a foreign object appropriately sized to simulate a polyp between the two layers of tissue.

33. The method of claim 29 wherein the gastrointestinal tract section is an upper gastrointestinal tract section comprising a biliary tree or portion thereof, wherein the biliary tree or portion thereof comprises biliary ducts, the method further comprising:
placing one or more foreign objects appropriately sized to simulate bile stones in at least one of the biliary ducts.

34. The method of claim 29 further comprising:
injecting a colored liquid into the tissue of the gastrointestinal tract section at at least one point of the gastrointestinal tract section to generate a discolored area in the wall of the gastrointestinal tract section that simulates a tumor.
